(19) United States
(12) Patent Application Publication
(10) Pub. No.: US 2012/0201949 A1
(43) Pub. Date: Aug. 9, 2012

(54) METHOF OF PRODUCING SOLAR SALT

(75) Inventors: Min Kyung Lee, Seoul (KR); Won Dae Chung, Seoul (KR)

(73) Assignee: CJ Cheiljedang Corp., Seoul (KR)

(21) Appl. No.: 13/500,463

(22) PCT Filed: Oct. 8, 2010
(86) PCT No.: PCT/KR10/06916

§ 371 Date: Apr. 5, 2012

(30) Foreign Application Priority Data
Oct. 9, 2009 (KR) 10-2009-0096409

(51) Int. Cl. A23L 1/237

(52) U.S. Cl. 426/648; 426/472

(57) ABSTRACT

A method of producing solar salt including putting dried solar salt into a color sorter to selectively remove foreign substances. The dried solar salt may be obtained by removing bittern from raw solar salt collected from a salt pond to obtain bittern-removed solar salt; washing the bittern-removed solar salt with concentrated brine to remove foreign substances; naturally dehydrating the washed solar salt to a water content of about 12 w/w % to about 17 w/w % by storing the same in a ton bag having a mesh bottom, to obtain dehydrated solar salt; and drying the dehydrated solar salt by heating. Solar salt, which is hygienically clean and is rich in mineral components, may be conveniently produced.

### TECHNICAL FIELD

The present invention relates to a method of producing solar salt, and more particularly, to a method capable of mass producing high-quality solar salt by which foreign substances may be efficiently removed from the solar salt, and which may prevent a loss of minerals from the solar salt.

### BACKGROUND ART

Solar salt is a natural salt attainable by pumping seawater into solar ponds and evaporating it with wind and sunlight. Solar salt is very nutritious with a variety of natural minerals from seawater, such as calcium, potassium, magnesium, and the like, which are essential for the human body, and with organic components from mud flats. Magnesium in solar salt facilitates cell metabolism and activation of enzymes and is involved in bone metabolism along with calcium and phosphate. In addition, calcium in solar salt enhances cell membranes and bones and is involved in the function of the heart muscle and nerves. Potassium in solar salt helps discharge waste from the body by water balance, controls muscle contraction, and is essential for neuromuscular actions.

The annual domestic output of solar salt is about three-hundred thousand tons, which accounts for about 43% of the total domestic salt consumption. Purified salt produced via purification for common use at home is hygienically clean, but contains solely 95% of sodium chloride and almost zero nutrients. However, solar salt is regarded as not being hygienically clean. For this reason, solar salt was classified as a mineral according to the Salt Control Law in 1963, and could not be registered with the Korean Food Code published in 1992. The Korea Food and Drug Administration (KFDA) re-stricted the use of solar salt only for preserving cabbage, fish, and the like. Since then solar salt was used at home when producing Kimchi or fermented paste or salting fish, but could not be used to produce processed foods in the industry.

Solar salt producers have been in full motion nationwide to acknowledge the functionality and safety of solar salt as food. As a result, solar salt was finally announced as food in the Korean Food Code in 2008 by the KFDA via the verification of the nutrients and safety of solar salt based on a research report submitted by solar salt producers and the KFDA's own analysis results.

General processes of producing solar salt involve collecting raw solar salt from solar ponds, and removing water from the raw solar salt by storing the raw solar salt in a salt storehouse for a certain period to remove bittern and produce obtain good texture salt. However, if the bittern is insufficiently removed, the final solar salt may be wet, and moisture may smear out of packages of the salt, thereby inconveniencing use of it. Furthermore, if the bittern is not completely removed, the final solar salt may have a bitter taste. Solar salt producing companies mostly use centrifugal dehydrators in order to remove moisture from salt as quickly as possible. However, such forced removal of moisture with centrifugal dehydrators may result in a loss of various minerals from the solar salt along with moisture. Such a loss of minerals that are essential for the human body during the removal of moisture in the production of solar salt may be problematic.

In order to retain mineral components in solar salt, a variety of methods have been suggested which include mechanically boiling seawater, or drying seawater by spray drying. However, these methods are not easy to conduct. Furthermore, in order to increase mineral content in solar salt, externally adding extra components in producing solar salt has been also been used. However, methods of producing solar salt retaining inherent minerals that is convenient to use have not yet been developed.

Furthermore, producing solar salt by pumping seawater into salt ponds and mere evaporating the seawater with wind and sunlight is not hygienic enough, so refining is required to obtain solar salt free from foreign substances. However, though solar salt is recognized as food, there has not been insufficient research into technologies for effectively removing foreign substances from solar salt, such as insects, mud, and tree branches, which are inherently found in the natural environment of salt ponds where solar salt is produced, and thus, are prone to enter into solar salt.

Research into removing foreign substances from solar salt has mostly suggested washing solar salt with brine. However, this method involves, conventionally, manually picking up foreign substances from dried salt at a final stage. Korean Application Publication No. 2005-099474 discloses a solar salt refining method in which minerals, such as sericite and chlorite, are used to remove harmful materials from solar salt by adsorption. However, the safety of these additional minerals from dietary intake has not been fully approved, and the method involves uniformly spreading out solar salt for drying, which is unpractical on an industrial scale. It is even further worse that during such a drying process the solar salt is highly vulnerable to secondary contaminations by airborne contaminants.

Therefore, there is a demand for methods of effectively removing foreign substances from solar salt and removing water in a convenient way without loss of minerals in the production of solar salt in order to produce high-quality salt.

### DISCLOSURE OF INVENTION

### Technical Problem

Inventors of the present invention researched into methods of effectively removing foreign substances and water from solar salt without loss of minerals, and found a new method of removing foreign substances from solar salt with a color sorter and a method of drying solar salt with a ton bag, thereby completing the present invention.

The present invention provides a method of producing high-quality solar salt free from foreign substances without loss of minerals.

The present invention provides a high-quality solar salt produced by the method, the solar salt without loss of minerals and being free from foreign substances.

### Solution to Problem

In order to solve the technical problem, there is provided a method of producing solar salt, the method including putting dried solar salt into a color sorter to selectively remove foreign substances.

The dried solar salt may be obtained by removing bittern from raw solar salt collected from a salt pond to obtain bittern-removed solar salt; washing the bittern-removed solar salt with concentrated brine to remove foreign substances; naturally dehydrating the washed solar salt to a water content of about 12 w/w % to about 17 w/w % by storing the same in a ton bag having a mesh bottom, to obtain dehydrated solar salt; and drying the dehydrated solar salt by heating.

Hereinafter, aspects of the present invention will be described in detail.

The present invention newly found that foreign substances may be effectively removed from solar salt by using a color sorter. The present invention also found that solar salt may be conveniently dried without loss of inherent mineral components by using a ton bag with a mesh bottom for storage to allow natural dehydration during a process of removing water from the solar salt. Thus, the present invention was completed.

According to an aspect of the present invention, a method of producing solar salt includes putting dried solar salt into a color sorter to selectively remove foreign substances.

The dried solar salt may be obtained by: removing bittern from raw solar salt collected from a salt pond to obtain bittern-removed solar salt; washing the bittern-removed solar salt with concentrated brine to remove foreign substances; naturally dehydrating the washed solar salt to a water content of about 12 w/w % to about 17 w/w % by storing the same in a ton bag having a mesh bottom, to obtain dehydrated solar salt; and drying the dehydrated solar salt by heating.

Considering the inherent characteristics of solar salt, a final product of dried solar salt may contain foreign substances even after being washed with concentrated brine. Thus, it is necessary to remove the foreign substances from the dried solar salt. To this end, according to the present invention, a color sorter, which has never been used for producing solar salt, is used in removing foreign substances from solar salt for a re-markably higher removal efficiency than in conventional production methods. Once dried solar salt is put into the color sorter, the solar salt is delivered by a quantitative supplying device to pass a site irradiated by a light source. The amounts of light transmitted and reflected from the solar salt are read and compared with reference values. Then, colored substance that does not fall within a predetermined allowable range of differences between the measured values and the reference values is removed by an air-jet system. This is the principle of removing foreign substances from solar salt in the present invention. The color sorter enable about 18 tons of foreign substances (mud, black particles, and the like) to be removed per day (a day of 8 hours), which is about 10 times higher in efficiency as compared to manually removing the same amount of foreign substances. Any type of color sorter may be used. Examples of available color sorters include any color sorting machine produced by SORTEX (UK), TOYO (Japan), and SADAKE (Japan) for grain sorting and other industrial uses.

In the method of producing the dried solar salt according to embodiments, initially bittern may be removed from raw solar salt collected from a salt pond. The raw solar salt may be stored in a salt warehouse for about 4 to about 10 weeks until the water content reaches about 12 w/w % to about 17 w/w %. While the raw solar salt is stored in the salt warehouse, the bittern may naturally drain from the raw solar salt into the floor of the salt warehouse, and thus the bittern may be removed from the raw solar salt.

Then, in order to remove the foreign substances from the bittern-removed raw solar salt, the raw solar salt may be washed with concentrated brine. The concentrated brine may have a salinity of about 25 to about 28 degrees Baume(° Be). Once the raw solar salt is put into a washing system, the raw solar salt is moved by screws towards an outlet while the concentrated brine in an amount of about 1 to 2 times by volume of the raw solar salt is sprayed, so that the foreign substances may be removed from the raw solar salt. The concentrated brine may have a salinity of about 25 to about 28° Be. However, the concentrated brine may have any salinity provided that it is saturated to the extent that the solar salt can not be dissolved any longer. For example, the concentrated brine may have a salinity of about 25 to about 28° Be, which is just slightly lower than the level at which salt crystals may be generated. By the method of producing solar salt according to the embodiment of the present invention described above, more hygienically clean solar salt from which foreign substances is removed may be produced due to the washing process with brine in addition to the use of the color sorting machine .

Next, the solar salt washed with the concentrated brine may be naturally dehydrated by being stored in the ton bag having the mesh bottom to let water drain. The mesh bottom of the ton bag may be formed of any mesh provided that it is suitable to accommodate the washed solar salt and allow natural dehydration. For example, the ton bag having the mesh bottom may be any mesh ton bag manufactured for delivering and storing perishable grains or vegetables (onions, potatoes, sweet pumpkins, and the like), and in particular, a ton bag having the mesh at its bottom. Meshed ton bags are commercially available from many ton bag makers. If the water content after the natural dehydration is above the range of 12-17%, the color of solar salt may change to yellow during the subsequent drying process by heating, which may degrade a consumer s preference to the final solar salt. Thus, the solar salt containing an excess of water immediately after being washed with the concentrated brine may be dried by natural dehydration to a water content of about 12 w/w % to about 17 w/w %, which is equal to the water content immediately after the removal of the bittern. The duration of the natural dehydration may vary according to the ambient temperature and/or humidity during the natural dehydration process. For example, the natural dehydration duration may be about 2 to about 4 days. While the solar salt washed with the concentrated brine is left in the ton bag having the mesh bottom, the water in the solar salt may naturally draw downwards and drain through the bottom mesh of the ton bag. By such natural dehydration the washed solar salt may be dried without loss of inherent mineral components of the solar salt, unlike conventional drying processes by centrifugation by which mineral components are lost along with water.

The naturally dehydrated solar salt is subjected to the drying process by heating to be more completely dried. In the drying process by heating, the dehydrated solar salt is placed in a dryer and may be heated at a temperature of about 120° C. to about 250° C. until the final water content reaches about 5 w/w % to about 8 w/w %. The drying time may vary according to the drying temperature. For example the drying time may be about 10 minutes to about 15 minutes. If the final water content is above this range, the final solar salt may wet to the exterior of the packing paper containing it and stick to fingers, which lowers consumer's preference. Furthermore, grains of the solar salt may stick to each other, which inconveniences in weighing an appropriate amount of it for use. Thus, in order to produce solar salt that is convenient to use and shows high consumer preference in appearance, the drying process by heating may be performed until the final water content reaches about 5 w/w % to about 8 w/w %.

The embodiment of the method of producing solar salt described above is illustrated as a flowchart in FIG. 1.

According to another aspect of the present invention, a solar salt produced by the method described above is provided.

The solar salt according to embodiments of the present invention is very efficiently produced in that foreign substances are removed by using a color sorter so that the solar salt is very hygienically clean to eat, thereby getting rid of the unhygienic issue of conventional solar salt. In addition, the solar salt according to embodiments of the present invention is highly nutritious with its inherent mineral components that remain without a loss during hydration since the solar salt is produced via natural hydration for which the solar salt is placed in a ton bag having a mesh bottom.

### Advantageous Effects of Invention

As described above, in the solar salt production method according to embodiments of the present invention, foreign substances may be efficiently removed from the solar salt by using a color sorter, which was not used in conventional methods. The method further includes washing the solar salt with concentrated brine when preparing the dried solar salt from which foreign substances are removed by using the color sorter. Thus, hygienically clean solar salt from which foreign substances are effectively removed may be produced. Moreover, when drying the solar salt, the solar salt is naturally dehydrated by storing the solar salt in a ton bag having a mesh bottom to let water drain. This natural dehydration prevents a loss of inherent mineral components of the solar salt and is convenient to implement. Therefore, according to embodiments of the present invention, a solar salt may be produced which is hygienically clean and is rich in mineral components.

### BRIEF DESCRIPTION OF DRAWINGS

FIG. 1 is a flowchart of a method of producing solar salt, according to an embodiment of the present invention.

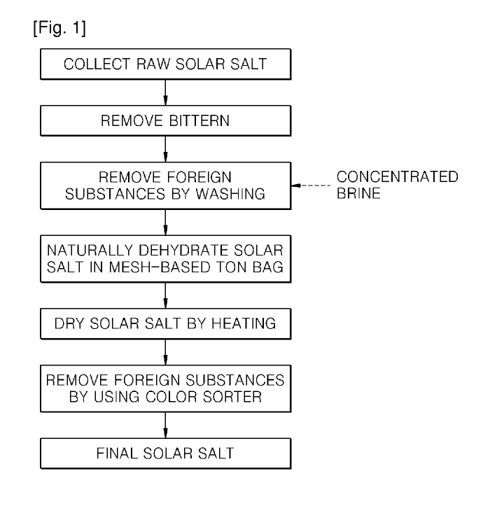

### MODE FOR THE INVENTION

The present invention will be described in further detail with reference to the following examples. These examples are for illustrative purposes only and are not intended to limit the scope of the present invention.

### Example 1

### Production of Solar Salt

Two tons of raw solar salt collected from a salt pond were stored in a salt warehouse for 8 weeks to let bittern drain into the floor. About 1.5 tons of the raw solar salt from which the bittern was drained was placed in a washing system and washed with about 1.5 tons of concentrated brine of about 25 to about 28° Be that was sprayed over the raw solar salt being moved towards an outlet of the washing system by screws, to remove foreign substances stuck to the solar salt. The washed solar salt was stored in a ton bag having a mesh bottom (custom-made by BokYoung Industry Co., Ltd) for 2 days to allow natural dehydration. The water content of the solar salt after the storage for 2 days was about 15 w/w %. The naturally dehydrated solar salt was placed in a dryer and dried at 200° C. for 10 minutes to a final water content of about 5 w/w % to about 8 w/w %. About 1 ton of the dried solar salt was placed in a color sorter (GP3400, DAEWON GSI Co., Ltd) to remove color foreign substances that did not fall within an allowable reference range by an air-jet system, thereby completing the production of solar salt.

### Comparative Example 1

### Production of Solar Salt Via Force Dehydration by Using Centrifuge

For comparison with the solar salt produced in Example 1, solar salt was produced by forcedly removing water from the solar salt by centrifugation. The raw solar salt collected from the same solar ponds as Example 1 was subjected to the same processes as those in Example 1 to remove the bittern from the raw solar salt and then to wash it. Then, the washed solar salt was dehydrated by centrifugation at about 500 rpm for about 300 seconds until the final water content reached about 5 w/w % to about 8 w/w %. Then, foreign substances were manually picked out from the dehydrated solar salt by two trained workers, thereby completing the production of solar salt.

### Experimental Example 1

### Mineral Content Analysis of Solar Salt

The water contents and mineral contents of the solar salts produced in Example 1 and Comparative Example 1 were measured. The water content was measured by oven-drying method, and the mineral content was measured by inductively coupled plasma (ICP) spectroscopy. In addition, the efficiencies of the two different foreign substance screening methods used in Example 1 and Comparative Example 1 were compared by measuring the time taken to remove foreign substances from one ton of the solar salt by using each method. A sensory evaluation was performed by twenty trained panelists in terms of shape appearance and taste. The results are shown in Table 1 below.

TABLE 1

| | Comparative | |
|---|---|---|
| | Example 1 | Example 1 |
| Water content | 5.49 | 5.27 |
| Sodium content | 35360.41 | 35904.17 |
| (mg/100 g) | | |
| Minerals content | | |
| (mg/100 g) | | |
| Magnesium (Mg) | 304.57 | 503.49 |
| Potassium (K) | 188.31 | 311.49 |
| Calcium (Ca) | 79.49 | 94.52 |
| Total | 572.37 | 909.5 |
| Time taken to remove | 240 min | 25 min |
| foreign substances | | |
| (per 1 ton of solar salt) | | |
| Shape appearance | Wet to stick to | Moistless to not stick to |
| | fingers when held | fingers when held in the |
| | in the hand | hand, and easy to spoon out |
| Taste | Salty first taste, but | No enhanced bitter taste as |
| | bitter aftertaste | compared to the forcedly |
| | | dehydrated salt |

1. A method of producing solar salt, the method comprising putting dried solar salt into a color sorter to selectively remove foreign substances.

2. The method of claim 1, wherein the dried solar salt is obtained by:
removing bittern from raw solar salt collected from a salt pond to obtain bittern-removed solar salt; washing the bittern-removed solar salt with concentrated brine to remove foreign substances; naturally dehydrating the washed solar salt to a water content of about 12 w/w % to about 17 w/w % by storing the same in a ton bag having a mesh bottom, to obtain dehydrated solar salt; and drying the dehydrated solar salt by heating.

3. The method of claim 2, wherein the removing of the bittern comprises storing the raw solar salt collected from the solar ponds in a salt warehouse for about 4 to about 10 weeks to a water content of about 12 w/w % to about 17w/w %.

4. The method of claim 2, wherein the concentrated brine has a salinity of about 25 to about 28 degrees Baume (° Be).

5. The method of claim 2, wherein a duration for the naturally dehydrating of the washed solar salt in the ton bag is from about 2 days to about 4 days.

6. The method of claim 2, wherein the drying of the dehydrated solar salt by heating comprises heating the dehydrated solar salt in a dryer at a temperature of about 120° C. to about 250° C. to a water content of about 5 w/w % to about 8 w/w %.

7. A solar salt produced by the method of claim 1.

8. A solar salt produced by the method of claim 2.

9. A solar salt produced by the method of claim 3.

10. A solar salt produced by the method of claim 4.

11. A solar salt produced by the method of claim 5.

12. A solar salt produced by the method of claim 6.
